(19) United States
(12) Patent Application Publication
(10) Pub. No.: US 2024/0292489 A1
(43) Pub. Date: Aug. 29, 2024

(54) DETERMINING METHOD FOR DISCONTINUOUS RECEPTION MODE, AND COMMUNICATION DEVICE, AND STORAGE MEDIUM

(71) Applicant: Beijing Xiaomi Mobile Software Co., Ltd., Beijing (CN)

(72) Inventors: Qin MU, Beijing (CN); Xuemei QIAO, Beijing (CN); Kexin XIONG, Beijing (CN)

(73) Assignee: Beijing Xiaomi Mobile Software Co., Ltd., Beijing (CN)

(21) Appl. No.: 18/696,395

(22) PCT Filed: Sep. 29, 2021
(86) PCT No.: PCT/CN2021/121868

§ 371 Date: Mar. 28, 2024

(51) Int. Cl. H04W 76/28

(52) U.S. Cl. CPC H04W 76/28

(57) ABSTRACT

A discontinuous reception (DRX) mode determining method, including: determining an error of a predicted moment when a data packet arrives at the terminal; and determining a DRX mode used by the terminal according to the error, where the DRX mode includes a first mode of determining a DRX configuration according to the predicted moment when the data packet arrives and a second mode corresponding to a preset DRX configuration.

### CROSS-REFERENCE TO RELATED APPLICATIONS

The present application is a U.S. National Stage of International Application No. PCT/CN2021/121868, filed on Sep. 29, 2021, the contents of all of which are incorporated herein by reference in their entireties for all purposes.

### BACKGROUND OF THE INVENTION

In the related art, for example, a 5th Generation (5G) cellular mobile communication network utilizes a discontinuous reception (DRX) mechanism to reduce energy consumption of a terminal, achieving a purpose of power saving in a manner of configuring the terminal with a sleep duration in a DRX cycle. The DRX cycle includes: on time and off time. The terminal transmits data during the on time and stops data transmission during the off time, i.e., sleep time to achieve an effect of power saving.

### SUMMARY OF THE INVENTION

According to a first aspect of the examples of the disclosure, a discontinuous reception (DRX) mode determining method is provided, the method including: determining an error of a predicted moment when a data packet arrives at a terminal; and determining a DRX mode used by the terminal according to the error, where the DRX mode includes a first mode of determining a DRX configuration according to the predicted moment when the data packet arrives and a second mode corresponding to a preset DRX configuration.

According to a second aspect of the examples of the disclosure, a communication device apparatus is provided, including a processor and a memory, and the processor is configured to: determine an error of a predicted moment when a data packet arrives at a terminal; determine a DRX mode used by the terminal according to the error, where the DRX mode includes a first mode of determining a DRX configuration according to the predicted moment when the data packet arrives and a second mode corresponding to a preset DRX configuration . . . .

According to a third aspect of the examples of the disclosure, a non-transitory computer-readable storage medium is provided, storing an executable program, where the executable program, when executed by a processor, implements steps of the discontinuous reception mode determining method of the first aspect.

### BRIEF DESCRIPTION OF DRAWINGS

FIG. 1 is a schematic structural diagram of a wireless communication system illustrated according to an example.

FIG. 2 is a schematic flow diagram of a discontinuous reception mode determining method illustrated according to an example.

FIG. 3 is a schematic flow diagram of another discontinuous reception mode determining method illustrated according to an example.

FIG. 4 is a schematic flow diagram of yet another discontinuous reception mode determining method illustrated according to an example.

FIG. 5 is a schematic flow diagram of yet another discontinuous reception mode determining method illustrated according to an example.

FIG. 6 is a schematic flow diagram of yet another discontinuous reception mode determining method illustrated according to an example.

FIG. 7 is a block diagram of a discontinuous reception mode determining apparatus illustrated according to an example.

FIG. 8 is a block diagram of an apparatus for determining a discontinuous reception mode illustrated according to an example.

### DETAILED DESCRIPTION OF THE INVENTION

Examples will be illustrated in detail here, and their instances are shown in drawings. When the following description refers to the drawings, unless otherwise indicated, the same numbers in different drawings indicate the same or similar elements. Implementations described in the following examples do not represent all implementations consistent with examples of the disclosure. Rather, they are merely instances of apparatuses and methods consistent with some aspects of the examples of the disclosure as detailed in the appended claims.

Terms used in the examples of the disclosure are merely for the purpose of describing specific examples, and not intended to limit the examples of the disclosure. Singular forms “one”, “said” and “the” used in the examples of the disclosure and the appended claims are also intended to include plural forms unless the context clearly indicates other meanings. It is also to be understood that a term “and/or” as used here refers to and includes any or all possible combinations of one or more associated listed items.

It is to be understood that although terms first, second, third, etc. may be used to describe various pieces of information in the examples of the disclosure, such information is not to be limited to these terms. These terms are merely used for distinguishing the same type of information from each other. For example, without departing from the scope of the examples of the disclosure, first information may also be referred to as second information, and similarly, the second information may also be referred to as the first information. Depending on the context, for example, a word “if” as used here may be interpreted as “at the time” or “when” or “in response to determining”.

The disclosure relates to but is not limited to the technical field of wireless communication, in particular to a discontinuous reception (DRX) mode determining method and apparatus, a communication device, and a storage medium.

Referring to FIG. 1, it shows a schematic structural diagram of a wireless communication system provided by an example of the disclosure. As shown in FIG. 1, the wireless communication system is a communication system based on a cellular mobile communication technology. The wireless communication system may include: a plurality of terminals 11 and a plurality of base stations 12.

The terminals 11 may refer to devices that provide a user with speech and/or data connectivity. The terminals 11 may communicate with one or more core networks via a radio access network (RAN). The terminals 11 may be internet of things terminals, such as sensor devices, mobile phones (or called “cellular” phones) and computers with internet of things terminals. For example, the terminals may be fixed, portable, pocket-size, handheld, computer built-in or vehicle-mounted apparatuses, such as stations (STAs), subscriber units, subscriber stations, mobile stations, mobiles, remote stations, access points, remote terminals, access terminals, user terminals, user agents, user devices, or user equipment (UE). The terminals 11 may also be unmanned aircraft devices. The terminals 11 may also be vehicle-mounted devices, such as a trip computer with a wireless communication function, or a wireless communication device connected with an external trip computer. The terminals 11 may also be roadside devices, such as a street lamp, a signal light or other roadside devices with wireless communication functions.

The base stations 12 may be network side devices in the wireless communication system. The wireless communication system may be the 4th generation mobile communication (4G) system, also called a long term evolution (LTE) system; or, the wireless communication system may also be a 5G system, also called a new radio (NR) system or 5G NR system. The wireless communication system may also be a next-generation system of the 5G system. An access network in the 5G system may be called a new generation-radio access network (NG-RAN). Or, it is an MTC system.

The base stations 12 may be evolved base stations (i.e., eNB) adopted in the 4G system. The base stations 12 may also be base stations (i.e., gNB) adopting centralized and distributed architectures in the 5G system. When the base stations 12 adopt the centralized and distributed architectures, they typically each include a central unit (CU) and at least two distributed units (DUs). Protocol stacks of a packet data convergence protocol (PDCP) layer, a radio link control (RLC) layer and a media access control (MAC) layer are disposed in the central unit; and protocol stacks of physical (PHY) layers are disposed in the distributed units, and specific implementations of the base stations 12 are not limited in the examples of the disclosure.

Wireless connections may be established between the base stations 12 and the terminals 11 through a wireless radio. In different implementations, the wireless radio is wireless radio based on the 4G standard; or, the wireless radio is wireless radio based on the 5G standard, such as new radio; or, the wireless radio may also be wireless radio based on the next-generation mobile communication standard of 5G.

In some examples, end to end (E2E) connections may also be established between the terminals 11. For example, vehicle to vehicle (V2V) communication, vehicle to infrastructure (V2I) communication and vehicle to pedestrian (V2P) communication in vehicle to everything (V2X) communication and other scenarios.

In some examples, the wireless communication system of FIG. 1 may further include a network management device 13.

The plurality of base stations 12 are connected with the network management device 13. The network management device 13 may be a core network device in the wireless communication system, for example, the network management device 13 may be a mobility management entity (MME) in an evolved packet core (EPC). The network management device may also be other core network devices, such as a serving gateway (SGW), a public data network gateway (PGW), a policy and charging rules function (PCRF) or a home subscriber server (HSS). An implementation form of the network management device 13 is not limited in the examples of the disclosure.

Execution entities involved in the examples of the disclosure include but are not limited to: UE such as mobile phone terminals that support cellular mobile communication, base stations, etc.

An application scenario of the examples of the disclosure is that: usually, a fixed sleep time duration is used in a DRX cycle, however, this manner is not able to adapt to a change in arrival time of a data packet, which may lead to a large delay.

In the related art, an artificial intelligence (AI) method is used to predict the time when the data packet arrives at one terminal and dynamically adjust a configuration of the DRX cycle according to a prediction result, so that the terminal accurately wakes up before the data packet arrives and enters into a sleep state when no data packet arrives. Thus minimizing energy consumption of the terminal under a condition of guaranteeing a data transmission delay.

A recurrent neural network (RNN) may be used for predicting the arrival time of the data packet. A long short term memory (LSTM) network is a popular RNN. A jitter delay sequence of historical data packet arrivals may be used as training data to train an LSTM model, and then the trained model is used at each data packet arrival for predicting a jitter delay value of a next data packet arrival.

The use of an artificial intelligence model prediction result for dynamically adjusting a sleep cycle duration of DRX can achieve a relatively good performance in most cases, with a small average error in prediction. However, when there is a sudden change in the data packet arrival, the prediction error is large, and if the DRX sleep configuration is still adjusted according to the prediction result, it cannot accurately match with the actual arrival of the data packet, which may bring about a large delay and generate excess energy consumption.

Thus, when there is the sudden change in the data packet arrival and the Al prediction result is inaccurate, how to adjust the sleep cycle duration of DRX to adapt to the change in the arrival time of the data packet is an urgent problem to be solved. The methods and systems described herein are able to more accurately determine the prediction result and therefore not only improve upon current systems, but also improve the functioning and energy consumption of the system.

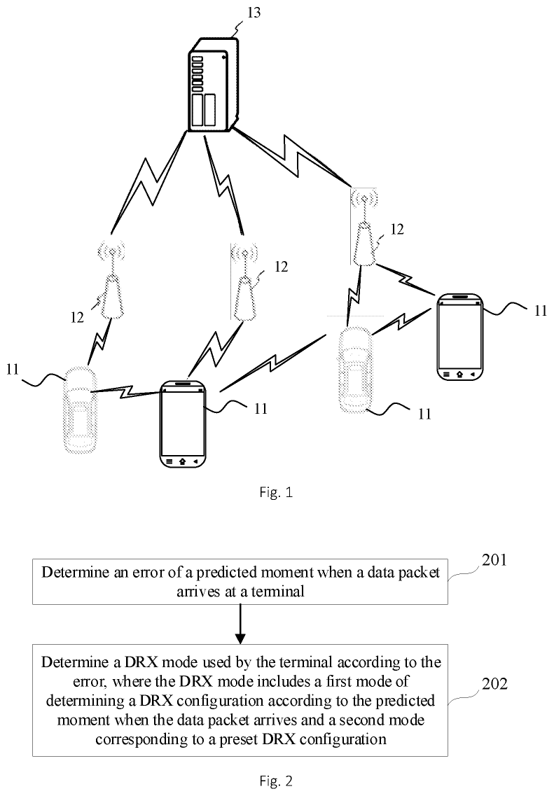

As shown in FIG. 2, the example provides a discontinuous reception mode determining method, and the discontinuous reception mode determining method may be applied to a network side device and/or a terminal of a cellular mobile communication system. The method of FIG. 2 includes steps 201 and 202.

In step 201: an error of a predicted moment when a data packet arrives at the terminal is determined.

In step 202: a DRX mode used by the terminal is determined according to the error, where the DRX mode includes a first mode of determining a DRX configuration according to the predicted moment when the data packet arrives and a second mode corresponding to a preset DRX configuration.

The method disclosed by this example may be executed by the network side device in cellular mobile communication, e.g., it may be executed by a core network device, or may be executed by the terminal. The terminal may include: a mobile phone using a cellular mobile communication technology for wireless communication, etc.

In one example, the predicted moment is determined by a prediction model.

In another example, the preset DRX configuration is determined according to a base station side configuration or a communication protocol, or is a DRX configuration preset within the terminal, or is a DRX configuration previously used by the terminal. Thus the preset DRX configuration may also be referred to as a default DRX configuration.

The prediction model may be a model with artificial intelligence learning. The prediction model may be trained based on delay jitter of historical data packet arrivals as training data, and time when the data packet arrives at the terminal is predicted. Here, the prediction model may use a recurrent neural network, such as a long short term memory network.

Due to randomness of a data packet arrival, there is a sudden change, and thus there is the error in the predicted moment. The error becomes larger especially when there is the sudden change in the data packet.

The network side device and/or the terminal, etc. may monitor the error of the predicted moment when the data packet arrives.

In one example, the network side device and/or the terminal, etc. may determine the error of the predicted moment based on a difference between an actual moment when the data packet arrives at the terminal and the predicted moment. The predicted moment may be determined by the prediction model as previously described.

In one example, the DRX configuration includes: a configuration for DRX cycle. The configuration of the DRX cycle may include but is not limited to: a configuration of on time in the DRX cycle, and/or a configuration of off time in the DRX cycle, and/or a configuration for DRX cycle duration, etc. The off time may also be called sleep time. Types of the DRX cycle may include: a DRX long sleep cycle and/or a DRX short sleep cycle. For example, in the same set of configurations, a duration of the DRX long sleep cycle is typically greater than a duration of the DRX short sleep cycle.

The terminal may currently use the first mode or the second mode. The DRX mode currently used by the terminal may be a default DRX mode of an initial state, a DRX mode previously determined by the method disclosed in this example, or a DRX mode determined by other methods.

In the first mode, the network side device and/or the terminal, etc. may determine an end moment of the off time of the terminal and/or a start moment of the on time, etc. by means of the predicted moment when the data packet arrives at the terminal, and thus the configuration of the DRX cycle may be adjusted in real time according to the predicted moment. With the first mode, the configuration of the DRX cycle may be flexibly adjusted for a change in the predicted time when the data packet arrives.

In the second mode, the network side device and/or the terminal may transmit the data packet according to the preset DRX configuration. Since the DRX configuration usually uses a fixed DRX configuration, it cannot be adjusted in real time to adapt to a change in the arrival time of the data packet, which may result in a large delay.

However, when the first mode is used, due to the existence of an emergency and other situations of the data packet, the predicted moment generates a large error, which in turn makes the DRX configuration unable to accurately match with the actual arrival of the data packet, generating a larger delay and more energy consumption compared to the second mode in the emergency and other situations of the data packet.

Here, thus, selection of the first mode or the second mode may be determined based on the error. The first mode is used when there is no sudden change in the data packet, and DRX is flexibly adjusted according to the arrival of the data packet; and when there is a sudden change in the data packet, for example, when the predicted moment has a large error, the first mode is used to reduce an occurrence of a large delay and save power.

Here, the determined error may be the error corresponding to one data packet, or errors corresponding to a predetermined number of data packets or data packets in a predetermined length of time (all below are referred to as the errors of a plurality of data packets). The errors of the plurality of data packets may be errors corresponding to the plurality of data packets respectively, and may also be a statistical result of the errors corresponding to the plurality of data packets respectively, including, but not limited to, a cumulative value of the errors, an arithmetic mean, a weighted mean, etc.

In the example of the disclosure, a threshold of the error may be determined based on a setting issued by a network side or based on a communication protocol, the first mode is used if the error does not exceed the threshold, and the second mode is used if the error exceeds the threshold.

In this way, based on the error of the predicted moment, the first mode or the second mode is selected and used to determine the DRX configuration, and the DRX configuration that adapts to a change in the error is selected to reduce a problem of increased data transmission delay and power consumption due to inability of the DRX configuration to accurately match with an actual arrival of the data packet when the error is too large.

In this example, use of the first mode or the second mode may be determined by the network side device and/or the terminal. When the use of the first mode or the second mode is determined by the network side device, the terminal may be configured by the network side device to use the first mode or the second mode. When the use of the first mode or the second mode is determined by the terminal, the mode used by the terminal may be notified by the terminal to the network side device by means of uplink information, etc.

In one example, the determining a DRX mode used by the terminal according to the error includes: determining that the terminal uses the first mode in response to the error being within a preset range; or determining that the terminal uses the second mode in response to the error being beyond, or not within, the preset range.

The error being within the preset range indicates that accuracy of the determined predicted time is high, and the error is acceptable. The DRX configuration determined by the first mode based on the predicted time is capable of matching with transmission of the data packet, and/or the delay and power consumption generated by the DRX configuration determined by the first mode based on the predicted time are within an acceptable range, and/or the delay and power consumption generated by the DRX configuration determined by the first mode based on the predicted time are better than the delay and power consumption generated by the DRX configuration determined by the second mode. Thus, the use of the first mode may be determined.

The error being beyond, or not within, the preset range indicates that the accuracy of the determined predicted time is low, and the error is unacceptable. The DRX configuration determined by the first mode based on the predicted time is not capable of matching with the transmission of the data packet, and/or the delay and power consumption generated by the DRX configuration determined by the first mode based on the predicted time are within an unacceptable range, and/or the delay and power consumption generated by the DRX configuration determined by the first mode based on the predicted time are worse than the delay and power consumption generated by the DRX configuration determined by the second mode. Thus, the use of the second mode may be determined.

The error in the DRX mode used by the terminal determined according to the error may be an error corresponding to one data packet or errors corresponding to a plurality of data packets. The errors of the plurality of data packets may be errors corresponding to the plurality of data packets respectively, and may also be a statistical result of the errors corresponding to the plurality of data packets respectively, including, but not limited to, a cumulative value of the errors, an arithmetic mean, a weighted mean, etc.

In an implementation, the preset range may be determined based on a setting issued by the network side or based on a communication protocol. In another implementation, the preset range may be determined based on an effect of the error on the first mode. The preset range needs to satisfy that when the error is within the preset range, the DRX configuration determined by the first mode may match with the actual arrival of the data packet, and/or have a better delay, power consumption, etc. compared to the second mode.

In this way, based on whether the error of the predicted moment is within the preset range, it is determined that the first mode or the second mode is selected for determining the DRX configuration. When the error is within the preset range, the first mode may be used for determining the DRX configuration flexibly to adapt to the change in the data packet, and to reduce the data transmission delay. When the error is beyond, or not within, the preset range, the second mode is used for determining the DRX configuration, and problems of a large data transmission delay and increased power consumption due to inability of the DRX configuration determined by the first mode to accurately match with the actual arrival of the data packet caused by the excessive error may be reduced.

In one example, the error being within a preset range includes at least one of M errors respectively corresponding to M data packets being greater than or equal to a first error threshold, and M being a natural number smaller than or equal to an overrunning number threshold; or a cumulative sum of each of a plurality of errors respectively corresponding to a plurality of data packets transmitted during an error monitoring cycle being smaller than a second error threshold.

In an implementation, M may be determined based on a setting issued by the network side or based on a communication protocol. For example, a numerical value of M may be directly determined. For another example, M data packets transmitted in a time interval are determined, i.e., only one time interval is determined, and M is determined according to actual transmission in the time interval; and the time interval may be determined based on a setting issued by the network side or based on a communication protocol.

Here, the network side device and/or the terminal may determine, when the first mode is used, whether the error is within the preset range, and if the error is within the preset range, the use of the first mode is maintained. The network side device and/or the terminal may also determine, when the second mode is used, whether the error is within the preset range, and if the error is within the preset range, the first mode is used.

For example, the first error threshold as well as an overrunning number-of-times threshold may be set in advance. Errors greater than the first error threshold are counted. When an error is greater than or equal to the first error threshold, 1 is added to the count value M. If M is smaller than or equal to the overrunning number-of-times threshold, the first mode may be used for determining the DRX configuration.

The second error threshold as well as the error monitoring cycle may also be set in advance. During the error monitoring cycle, each error is added up. The first mode may be used for determining the DRX configuration if the cumulative value of the errors during the error monitoring cycle is smaller than or equal to the second error threshold. The cumulative value may be zeroed at a start moment and/or an end moment of the error monitoring cycle to reduce an effect on a subsequent error monitoring cycle.

The DRX mode may be determined based on the first error threshold alone, the DRX mode may also be determined based on the second error threshold alone, and the DRX mode may further be determined in combination with the first error threshold and the second error threshold together. For example, when, in the second mode, use of the first mode is determined based on both the first error threshold and the second error threshold, the first mode is used, otherwise use of the second mode is maintained; or, when, in the first mode, the use the second mode is determined based on both the first error threshold and the second error threshold, the second mode is used, otherwise the use of the first mode is maintained.

Based on the same principle as previously described, in all examples of the disclosure, any one or more of the preset ranges, the first error threshold, and the second error threshold may be each determined based on the settings issued by the network side or based on the communication protocols, or be each determined based on the effect of the error on the first mode.

In one example, the first error threshold used by the terminal in the first mode is different from the first error threshold used by the terminal in the second mode; and/or the second error threshold used by the terminal in the first mode is different from the second error threshold used by the terminal in the second mode.

A requirement for switching from the first mode to the second mode may be different from a requirement for switching from the second mode to the first mode. The requirement for switching from the second mode to the first mode may be stricter than the requirement for switching from the first mode to the second mode.

For example, the first error threshold used in the first mode may be greater than the first error threshold used in the second mode. The second error threshold used in the first mode may also be greater than the second error threshold used in the second mode.

In one example, the M data packets include M continuous data packets.

Data of the successively occurring errors greater than or equal to the first error threshold may be counted. When the first mode is used, successive occurrences of the errors greater than or equal to the first error threshold indicate that there is a large deviation from the predicted moment, and that the DRX configuration determined by first mode with the predicted moment is unable to match with the data packet. Switching to the second mode is needed.

While the occasional error greater than or equal to the first error threshold has smaller effect on the DRX configuration.

In this way, accuracy of judging DRX mode switching may be improved by using the successively occurring errors as bases for switching the DRX mode, and interference of the occasional error in judging DRX mode switching may be reduced.

In one example, the method further includes updating M by using a difference of M minus 1 (i.e., M=M−1) in response to the error corresponding to one of the M data packets being smaller than the first error threshold.

In response to the error being greater than or equal to the first error threshold, 1 is added to the count value M (i.e., M=M+1); or in response to the error being smaller than the first error threshold, 1 is subtracted from the count value M (i.e., M=M−1). If M is smaller than or equal to the overrunning number-of-times threshold, the first mode may be used for determining the DRX configuration. In this way, it is implemented that the DRX mode is switched only when the large errors occur successively. If M is 0 (zero), 1 (one) may be no longer subtracted from M.

In one example, the error being beyond, or not within, the preset range includes at least one of: N errors respectively corresponding to N data packets being greater than or equal to a first error threshold, and N being greater than an overrunning number threshold, where N is a positive integer; or a cumulative sum of each of a plurality of errors respectively corresponding to a plurality of data packets transmitted during an error monitoring cycle being greater than or equal to a second error threshold.

In an implementation, N may be determined based on a setting issued by the network side or based on a communication protocol. For example, a numerical value of N may be directly determined. For another example, N data packets transmitted in a time interval are determined, i.e., only one time interval is determined, and N is determined according to actual transmission in the time interval; and the time interval may be determined based on a setting issued by the network side or based on a communication protocol.

Here, the network side device and/or the terminal may determine, when the first mode is used, whether the error is beyond, or not within, the preset range, and if the error is beyond the preset range, the second mode is used. The network side device and/or the terminal may also determine, when the second mode is used, whether the error is beyond the preset range, and if the error is beyond the preset range, the use of second mode is maintained.

For example, the first error threshold as well as the overrunning number-of-times threshold may be set in advance. Errors greater than the first error threshold are counted. When an error is greater than or equal to the first error threshold, 1 is added to the count value N. If N is greater than the overrunning number-of-times threshold, the second mode may be used for determining the DRX configuration.

In one example, the N data packets include N continuous data packets.

Data of the successively occurring errors greater than or equal to the first error threshold may be counted. When the first mode is used, successive occurrences of the errors greater than or equal to the first error threshold indicate that there is a large deviation from the predicted moment, and that the DRX configuration determined by first mode with the predicted moment is unable to match with the data packet. Switching to the second mode is needed.

While the occasional error greater than or equal to the first error threshold has smaller effect on the DRX configuration.

In this way, accuracy of judging DRX mode switching may be improved by using the successively occurring errors as bases for switching the DRX mode, and interference of the occasional error in judging DRX mode switching may be reduced.

In one example, the method further includes updating N by using a difference of N minus 1 (i.e., N=N+1) in response to the error corresponding to one of the N data packets being smaller than the first error threshold.

1 (one) is added to the count value N (i.e., N=N+1) in response to the error being greater than or equal to the first error threshold, or 1 is subtracted from the count value N (i.e., N=N−1) in response to the error being smaller than the first error threshold. If N is greater than the overrunning number-of-times threshold, the second mode may be used for determining the DRX configuration. In this way, it is implemented that the DRX mode is switched only when the large errors occur successively. If N is 0 (zero), 1 (one) may be no longer subtracted from N.

For example, the second error threshold as well as the error monitoring cycle may be set in advance. During the error monitoring cycle, each error is added up. The first mode may be used for determining the DRX configuration if the cumulative value of the errors during the error monitoring cycle is smaller than or equal to the second error threshold. The cumulative value may be zeroed at a start moment and/or an end moment of the error monitoring cycle to reduce an effect on a subsequent error monitoring cycle.

The example provides the discontinuous reception mode determining method, and the discontinuous reception mode determining method may be applied to an electronic device of the cellular mobile communication system, where the network side device and/or the terminal at least have/has one preset DRX configuration and one DRX configuration based on the predicted moment. The electronic device, when using the DRX configuration based on the predicted moment, determines, according to the error, whether to continue to use the current DRX configuration based on the predicted moment or to switch to the preset DRX configuration.

Where the electronic device of the cellular mobile communication system may be the network side device and/or the terminal of the cellular mobile communication system.

In another example, similar to the previous example, the electronic device, when using the preset DRX configuration (the second mode), may determine, based on a preset switching condition, whether to switch to the DRX configuration based on the predicted moment (the first mode) or to continue to use the current preset DRX configuration (the second mode). It needs to be noted that the example may be executed independently or in conjunction with the previous example.

In one example, the determining a DRX mode used by the terminal according to the error includes determining the DRX mode used by the terminal according to the error after a lasting duration of the terminal using the second mode reaches a first duration.

For the terminal initially using the second mode, or, determining that the terminal switches to the second mode according to the error, certain switching conditions may be set, and when the conditions are met, the terminal may be controlled by the base station to switch or the terminal may switch the DRX mode.

It is possible to determine the predicted moment when the data packet arrives without further use of the prediction model, etc. when the lasting duration of the second mode is within the first duration. Usually, the sudden change of the data packet lasts for a period of time, and thus setting the first duration may reduce frequent switching between the first mode and the second mode, and reduce resource consumption of the network side device and/or the terminal. The first duration may be determined according to a lasting duration of the sudden change of the data packet or a network side configuration or a communication protocol, etc.

Within the first duration of the second mode, the predicted moment when the data packet arrives is determined, and the error is monitored. When the error is within the preset range, it is determined that the terminal switches to the first mode; and when the error is beyond, or not within, the preset range, it is determined that the terminal continues to use the second mode. In addition, a judgment of DRX mode switching is re-performed at the same time or before or after lasting time of the next second mode reaches the first duration.

In one example, the determining an error of a predicted moment when a data packet arrives at a terminal includes determining the error of the predicted moment when the data packet arrives at the terminal in a second duration of the terminal using the second mode.

For the terminal initially using the second mode, or, after determining that the terminal switches to the second mode according to the error, certain switching conditions may be set, and when the conditions are met, the terminal may be controlled by the base station to switch or the terminal may actively switch the DRX mode.

Here, the second duration in which the second mode is used may be within an entire duration range in which the second mode is used, or within a part of the duration range of the second mode; and it may be determined according to a network side configuration or a communication protocol.

For example, in a process of using the second mode, the predicted moment when the data packet arrives may be determined, and the error is monitored. When the error is within the preset range, it is determined that the terminal switches to the first mode; and when the error is beyond, or not within, the preset range, it is determined that the terminal continues to use the second mode. In addition, a judgment of DRX mode switching is re-performed in a next process of using the second mode.

In one example, the method further includes using the first mode after the lasting duration of the terminal using the second mode to reach a third duration.

Here, after the second mode is used to reach the third duration, the judgment of DRX mode switching may be no longer performed, and switching to the first mode may be performed directly. That is, after the second mode is used to reach the third duration, the predicted moment when the data packet arrives may be no longer determined, but the first mode is directly used for determining the DRX configuration.

In one example, a DRX cycle duration configured by the second mode includes: a minimum duration in a time interval of each of a plurality of data packets arriving at the terminal during a predetermined configuration period; or the DRX cycle duration configured by the second mode is a preset fixed duration.

In the second mode, the DRX cycle duration may be set before each entry into the second mode according to laws of recent arrivals of data packets, or may use the preset fixed duration.

For example, a method of configuring the DRX cycle duration by the second mode may include that: the network side device and/or the terminal may monitor a time interval of each of a plurality of data packets arriving at the terminal during a predetermined configuration period, and may determine a minimum duration in the time interval of each data packet arriving at the terminal during the predetermined configuration period as the DRX cycle duration. Here, the DRX cycle duration may include: a DRX short sleep cycle duration.

The method of setting the DRX cycle duration in the second mode may further include: setting a fixed DRX long sleep cycle duration, the DRX short sleep cycle duration, and the number a of times of lasting a DRX short sleep cycle. After entering into the second mode each time, the terminal first enters into the DRX short sleep cycle, and if no data packet arrives within a consecutive DRX short sleep cycle, the terminal enters into a DRX long sleep cycle.

In one example, the method further includes determining a duration of off time in the DRX cycle configured by the first mode based on a duration of an interval between an end moment of on time in the DRX cycle, and the predicted moment corresponding to the data packet after the end moment.

In the first mode, the network side device and/or the terminal, each time the data packet arrives at the terminal, predict/predicts arrival time of the next data packet according to historical arrival time of data packets and configure/configures the terminal with a duration of the off time in the DRX cycle according to the predicted moment.

The duration T of the off time=a predicted moment when a next predicted data packet arrives—an end moment of on time in a current DRX cycle.

The base station sets T as the duration of the off time in the next DRX cycle.

For example, the base station, according to the predicted moment when the next predicted data packet arrives, the off time (T) in the DRX cycle equals the predicted moment when the next predicted data packet arrives-actual arrival time of a current data packet-active time, where the terminal is used for decoding active state time of the data packet after the current data packet arrives.

The base station further sets two sleep cycle thresholds Tmin and Tmax, T is compared with the two sleep cycle thresholds respectively, and if T<Tmin, the terminal remains in an active state; if Tmin<T<Tmax, the terminal enters into the DRX short sleep cycle with sleep time of T; and if T>Tmax, the terminal enters into the DRX long sleep cycle with sleep time of T.

A specific example is provided in combination with any example herein. This example provides a DRX configuration mode determining method.

The base station may configure the terminal with two DRX modes, namely an artificial intelligence DRX (AI-DRX) mode, i.e., the first mode, and a Fixed-DRX mode, i.e., the second mode respectively.

a) In the Al-DRX mode, the network side device and/or the terminal, each time the data packet arrives at the terminal, predict/predicts arrival time of the next data packet according to historical arrival time of data packets and configure/configures the terminal with a duration of the off time in the DRX cycle according to the predicted moment.

The duration T of the off time equals a predicted moment when a next predicted data packet arrives—an end moment of on time in a current DRX cycle.

The base station sets T as the duration of the off time in the next DRX cycle.

For example, the base station, according to the predicted moment when the next predicted data packet arrives, the off time T in the DRX cycle=the predicted moment when the next predicted data packet arrives-actual arrival time of a current data packet-active time, where the terminal is used for decoding active state time of the data packet after the current data packet arrives.

The base station further sets two sleep cycle thresholds Tmin and Tmax, T is compared with the two sleep cycle thresholds respectively, and if T<Tmin, the terminal remains in an active state; if Tmin<T<Tmax, the terminal enters into the DRX short sleep cycle with sleep time of T; and if T>Tmax, the terminal enters into the DRX long sleep cycle with sleep time of T. Here the sleep time is the off time in the DRX cycle.

b) In the Fixed-DRX mode, a fixed sleep cycle is used. The DRX cycle may be set before each entry into the Fixed-DRX mode according to laws of recent arrivals of data packets, or may use a preset value.

In AI-DRX, each time the arrival time of the data packet is predicted by using an Al method, a prediction error is recorded by comparing the predicted moment with an actual moment of a real arrival of the data packet. Thus, the error is monitored in real time, and when the error meets preset conditions, the terminal is configured by the base station to switch to the Fixed-DRX mode. An error judgment condition for switching of the terminal from the AI-DRX mode to the Fixed-DRX mode may be a First Error judgment condition or a Second Error judgment condition.

The First Error judgment condition: the first error threshold as well as the overrunning number-of-times threshold are set. When the error exceeds the error threshold, 1 is added to an overrunning number of times. When the overrunning number of times exceeds the overrunning number-of-times threshold, the terminal switches to the Fixed-DRX mode, and the recorded overrunning number of times is zeroed. An option may further be set so that when the prediction error is smaller than the error threshold and the overrunning number of times is greater than zero, 1 is subtracted from the overrunning number of times. This option may guarantee that the DRX mode is switched only when large errors occur successively. When the overrunning number of times exceeds the overrunning number-of-times threshold, the base station controls the terminal to switch to the Fixed-DRX mode.

The Second Error judgment condition: the second error threshold as well as the error monitoring cycle are set. The error is added for each time during one error monitoring cycle, and a cumulative prediction error is zeroed when the error monitoring cycle ends/when the terminal enters into the Fixed-DRX mode. When the cumulative prediction error exceeds the error threshold, the base station controls the terminal to switch to the Fixed-DRX mode.

When the base station controls the terminal to switch to the Fixed-DRX mode, a fixed sleep cycle in the Fixed-DRX mode is to be set at the same time. A method for setting the fixed sleep cycle may be a First Method or a Second Method.

The First Method for setting a sleep cycle in the Fixed-DRX mode: a fixed DRX long sleep cycle, a DRX short sleep cycle, and the number a of times of lasting the DRX short sleep cycle are set. After entering into the Fixed-DRX mode each time, the terminal first enters into the DRX short sleep cycle, and if no data packet arrives within a consecutive DRX short sleep cycle, the terminal enters into the DRX long sleep cycle.

The Second Method for setting a sleep cycle in the Fixed-DRX mode: switching to the Fixed-DRX mode is ready each time, the interval of the data packet arriving at the terminal in a recent period of time is monitored, and if the arrival time interval of the data packet is smaller than the fixed DRX cycle, the DRX cycle in this Fixed-DRX lasting time is set as a minimum monitored arrival time interval of the data packet. Here, the DRX cycle may be the DRX short sleep cycle.

In the Fixed-DRX mode, certain switching conditions are set, and when the conditions are met, the base station controls the terminal to switch back to the Al-DRX mode. The switching conditions may be a First Switching judgment condition, a Second Switching judgment condition, or a Third Switching judgment condition.

The First Switching judgment condition: in the Fixed-DRX mode, the Al method continues to be used for predicting the arrival time of the data packet, and the error is monitored. When the error is small enough (a judgment method is the same as the first or second error judgment condition), switching back to the AI-DRX mode is performed.

The Second Switching judgment condition: a Fixed-DRX lasting duration is set, the arrival time of the data packet is no longer predicted in the Fixed-DRX mode, and switching back to the AI-DRX mode is performed when the lasting time of the Fixed-DRX mode is reached.

The Third Switching judgment condition: a Fixed-DRX lasting duration is set, and the arrival time of the data packet is not predicted in the Fixed-DRX lasting duration. When the lasting time of the Fixed-DRX mode is reached, the arrival time of the data packet starts to be predicted, and the error is monitored. When the error is small enough (a judgment method is the same as the first or second error judgment condition), switching back to the Al-DRX mode is performed; and when the switching condition is not met, the Fixed-DRX mode is still used, and the switching condition is re-judged when lasting time of a next Fixed-DRX mode is reached.

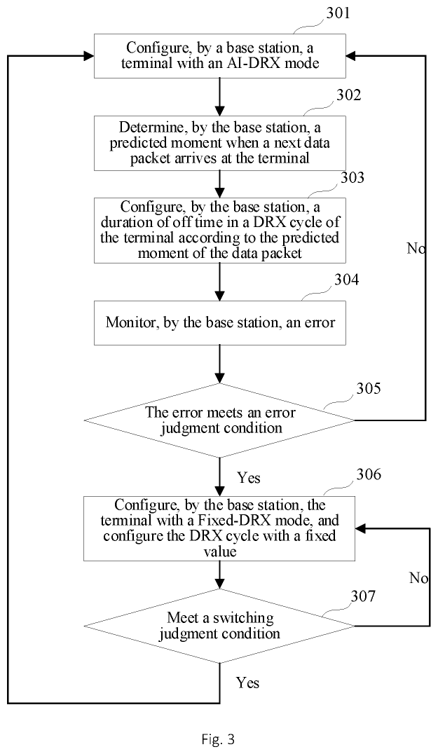

As shown FIG. 3, is a flow diagram based on a DRX configuration mode determining method provided by this example. Specific steps of FIG. 3 include steps 301-307.
Step 301, the base station configures the terminal with the AI-DRX mode and sets sleep cycle thresholds Tmin and Tmax.
Step 302, the base station uses an Al prediction model to determine a predicted moment when the next data packet arrives at the terminal.
Step 303, the base station configures a duration of the off time in the DRX cycle of the terminal according to the predicted moment of the data packet.

Further, step 303 may include the following steps, 303a, 303b and 303c, not shown in FIG. 3.
Step 303a, the base station computes the duration of the off time of the terminal according to the arrival time of the next data packet, as follows: the off time T in the DRX cycle equals the predicted moment when the next predicted data packet arrives-actual arrival time of a current data packet-active time, where the active time is the active time for which the terminal will last after the current data packet arrives.
Step 303b, the base station compares T with the two sleep cycle thresholds respectively, and if T<Tmin, the terminal remains in an active state; if Tmin<T<Tmax, the terminal enters into the DRX short sleep cycle with sleep time of T; and if T>Tmax, the terminal enters into the DRX long sleep cycle with sleep time of T. Here the sleep time is the off time in the DRX cycle.
Step 303c, the base station configures a sleep state and sleep time of the terminal according to a result obtained from comparison of the sleep cycle thresholds.

Returning to FIG. 3, in step 304, the base station monitors the error. After the base station determines the predicted moment each time, it compares the predicted moment with the actual arrival moment of the data packet, obtains the error, and monitors the error according to the error judgment conditions.
Step 305, if the base station monitors that the error meets the error judgment conditions, step 306 is executed, and otherwise the terminal remains in a state of the AI-DRX mode, and the method returns to step 301.
Step 306, the base station configures the terminal with the Fixed-DRX mode and configures the DRX cycle with a fixed value.
Step 307, the base station judges whether a preset DRX mode switching judgment condition is met. If yes, the base station controls the terminal to switch back to the Al-DRX mode; and otherwise, the terminal remains in the Fixed-DRX mode, and the method returns to step 306.

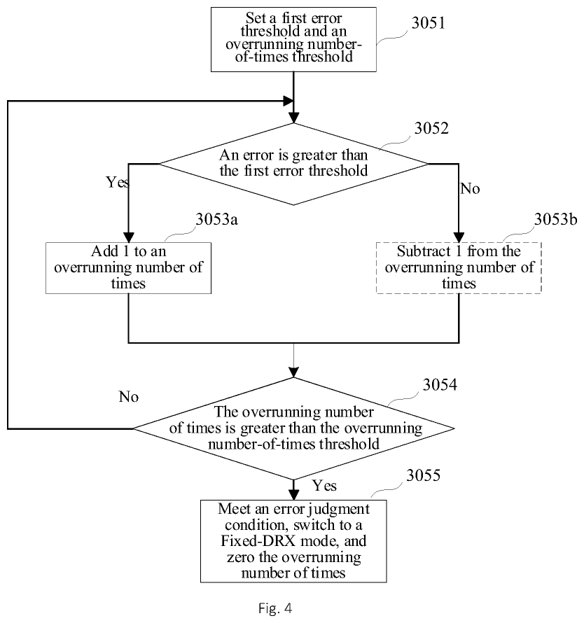

As shown in FIG. 4, specific steps of one manner in which the base station determines the DRX mode through the error judgment condition in step 305 of FIG. 3 include 3051-3055.
Step 3051, the base station sets the first error threshold as well as the overrunning number-of-times threshold. When the number of times of the monitored error exceeding the first error threshold reaches the overrunning number-of-times threshold, the error judgment condition is met.
Step 3052, each time the data packet arrives, the error for the data packet is compared to the first error threshold. When the error is greater than or equal to the first error threshold, the method proceeds to step 3053a, and when the error is less than the first error threshold, the method proceeds to step 3053b.
Step 3053a, if the error is greater than or equal to the first error threshold, 1 is added to an overrunning number of times. Optionally, if the error is smaller than the first error threshold and the overrunning number of times is greater than zero, step 3053b is performed and 1 is subtracted from the overrunning number of times. If this option is contained, it indicates that the error judgment condition is judged to be met only when large errors occur successively.
Step 3054, if the overrunning number of times is greater than the overrunning number-of-times threshold, step 3055 is executed. Otherwise, the AI-DRX mode is maintained to continue monitoring the error, and the method goes back to step 3052.
Step 3055, the error judgment condition is judged to be met, the overrunning number of times is zeroed, and the terminal is controlled to switch to the Fixed-DRX mode.

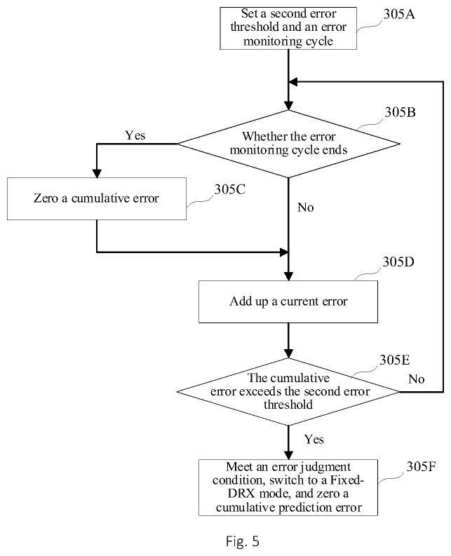

As shown in FIG. 5, specific steps of another manner in which the base station determines the DRX mode through the error judgment condition in step 305 of FIG. 3 include 305A-305E.
Step 305A, the base station sets the second error threshold as well as the error monitoring cycle. When the cumulative error within the error monitoring cycle is monitored to exceed the second error threshold, the error judgment condition is judged to be met. The error monitoring cycle may be either a time period or the number of times a data packet arrives, i.e., whether the error in a period of time or the error generated by predicting arrival time of a plurality of data packets is monitored.
Step 305B, each time the error is generated, it is first judged whether the error monitoring cycle ends. If the current error monitoring cycle has ended, step 305C is executed; and otherwise, step 305D is directly executed.
Step 305C, the cumulative error is zeroed.
Step 305D, the current error is added up to the cumulative error.
Step 305E, if the cumulative error exceeds the second error threshold, step 305F is executed; and otherwise, the AI-DRX mode is maintained to continue to monitor the error, and the method returns to step 305B.
Step 305F, the error judgment condition is judged to be met, a cumulative prediction error is zeroed, and the terminal is controlled to switch to the Fixed-DRX mode.

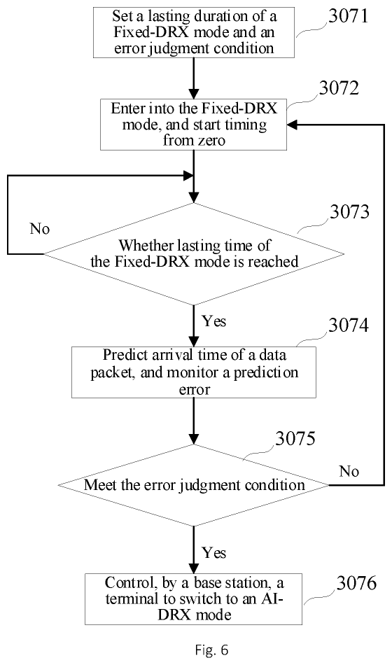

As shown in FIG. 6, specific steps of one manner in which the base station determines the DRX mode through the switching judgment condition in step 307 of FIG. 3 include 3071-3076.
Step 3071, the base station sets the lasting duration of the Fixed-DRX mode and the error judgment condition. The error judgment condition is similar in principle to the error judgment condition for switching from the AI-DRX mode to the Fixed-DRX mode, and will not be repeated here. Relevant parameters in the error judgment condition may be set flexibly as needed.
Step 3072, the base station controls the terminal to enter into the Fixed-DRX mode, i.e., timing is started from zero.
Step 3073, whether the lasting duration of the Fixed-DRX mode reaches the first duration is monitored, and if yes, step 3074 is executed. Otherwise, timing is continued, and time is monitored until the lasting duration of the Fixed-DRX mode reaches the first duration.
Step 3074, the base station starts to predict the arrival time of the data packet and monitor the error.
Step 3075, whether the error judgment condition is met is judged, and if yes, step 3076 is executed. Otherwise, the Fixed-DRX mode continues to be maintained, and timing is started from zero by returning to step 3072.
Step 3076, the base station controls the terminal to switch to the Al-DRX mode.

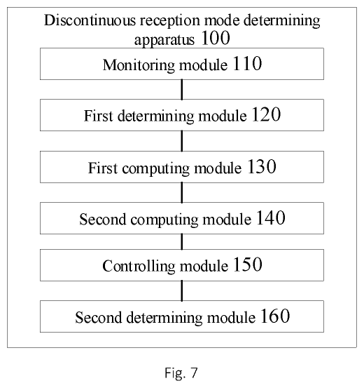

An example of the disclosure further provides a discontinuous reception mode determining apparatus 100 applied to a network side device and/or a terminal of wireless communication. As shown in FIG. 7, the discontinuous reception mode determining apparatus 100 includes a monitoring module 110, a first determining module 120, a first computing module 130, a second computing module 140, a controlling module 150, and a second determining module 160. While modules 110-160 are all shown in FIG. 7, it will be understood by those of ordinary skill in the art that the discontinuous reception mode determining apparatus 100 may include any combination of these modules, and that not all are required.

The monitoring module 110 is configured to determine an error of a predicted moment when a data packet arrives at a terminal.

The first determining module 120 is configured to determine a DRX mode used by the terminal according to the error, where the DRX mode includes a first mode of determining a DRX configuration according to the predicted moment when the data packet arrives and a second mode corresponding to a preset DRX configuration.

In one example, the first determining module 120 is specifically configured to: determine that the terminal uses the first mode in response to the error being within a preset range; or determine that the terminal uses the second mode in response to the error being beyond, or not within, the preset range.

In one example, the error being within a preset range includes at least one of: M errors respectively corresponding to M data packets being greater than or equal to a first error threshold, and M being a natural number smaller than or equal to an overrunning number threshold; or a cumulative sum of each of a plurality of errors respectively corresponding to a plurality of data packets transmitted during an error monitoring cycle being smaller than a second error threshold.

In one example, the M data packets include M continuous data packets.

The first computing module 130 is configured to update M by using a difference of M minus 1 in response to the error corresponding to one of the M data packets being smaller than the first error threshold.

In one example, the error being beyond, or not within, the preset range includes at least one of: N errors respectively corresponding to N data packets being greater than or equal to a first error threshold, and N being greater than an overrunning number threshold, where N is a positive integer; or a cumulative sum of each of a plurality of errors respectively corresponding to a plurality of data packets transmitted during the error monitoring cycle being greater than or equal to the second error threshold.

In one example, the N data packets include N continuous data packets.

The second computing module 140 is configured to update N by using a difference of N minus 1 in response to the error corresponding to one of the N data packet being smaller than the first error threshold.

In one example, the first determining module 120 is specifically configured to: determine the DRX mode used by the terminal according to the error after a lasting duration of the terminal using the second mode reaches a first duration.

In one example, the monitoring module 110 is specifically configured to: monitor the error of the predicted moment when the data packet arrives at the terminal in a second duration of the terminal using the second mode.

The controlling module 150 is configured to use the first mode after the lasting duration of the terminal using the second mode to reach a third duration.

In one example, the first error threshold used by the terminal in the first mode is different from the first error threshold used by the terminal in the second mode; and/or the second error threshold used by the terminal in the first mode is different from the second error threshold used by the terminal in the second mode.

In one example, the DRX configuration includes: a configuration for DRX cycle.

In one example, a DRX cycle duration configured by the second mode includes: a minimum duration in a time interval of each of a plurality of data packet arriving at the terminal during a predetermined configuration period; or the DRX cycle duration configured by the second mode is a preset fixed duration.

The second determining module 160, configured to determine a duration of off time in the DRX cycle configured by the first mode based on a duration of an interval between an end moment of on time in the DRX cycle, and the predicted moment corresponding to the data packet after the end moment.

In an example, the monitoring module 110, the first determining module 120, the first computing module 130, the second computing module 140, the controlling module 150, the second determining module 160, etc. may be implemented by one or more central processing units (CPUs), graphics processing units (GPUs), baseband processors (BPs), application specific integrated circuits (ASICs), DSPs, programmable logic devices (PLDs), complex programmable logic devices (CPLDs), field-programmable gate arrays (FPGAs), general-purpose processors, controllers, micro controller units (MCUs), microprocessors or other electronic elements to execute the aforementioned method.

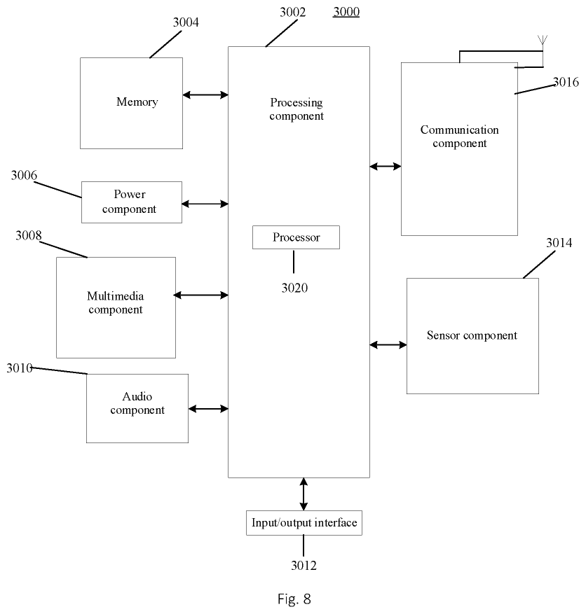

FIG. 8 is a block diagram of an apparatus 3000 for determining a discontinuous reception mode illustrated according to an example. For example, the apparatus 3000 may be a mobile phone, a computer, a digital broadcasting terminal, a messaging device, a game console, a tablet device, a medical device, a fitness device, a personal digital assistant, etc.

Referring to FIG. 8, the apparatus 3000 may include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 typically controls the overall operation of the apparatus 3000, such as operations associated with display, a telephone call, data communication, a camera operation, and a recording operation. The processing component 3002 may include one or more processors 3020 to execute instructions to complete all or part of the steps of any of the methods described herein. In addition, the processing component 3002 may include one or more modules to facilitate interaction between the processing component 3002 and other components. For example, the processing component 3002 may include a multimedia module to facilitate interaction between the multimedia component 3008 and the processing component 3002.

The memory 3004 is configured to store various types of data to support operations at the apparatus 3000. Examples of these data include instructions for any application or method operating on the apparatus 3000, contact data, phone book data, messages, pictures, videos, etc. The memory 3004 may be implemented by any type of volatile or nonvolatile storage device or their combination, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk.

The power component 3006 provides power for various components of the apparatus 3000. The power component 3006 may include a power management system, one or more power sources and other components associated with generating, managing and distributing power for the apparatus 3000.

The multimedia component 3008 includes a screen providing an output interface between the apparatus 3000 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense a touch, sliding and gestures on the touch panel. The touch sensor may not only sense the boundary of the touch or sliding motion, but also detect the duration and pressure related to the touch or sliding operation. In some examples, the multimedia component 3008 includes a front camera and/or a rear camera. When the apparatus 3000 is in an operation mode, such as a shooting mode or a video mode, the front camera and/or the rear camera can receive external multimedia data. Each front camera and rear camera may be a fixed optical lens system or have a focal length and optical zoom capability.

The audio component 3010 is configured to output and/or input audio signals. For example, the audio component 3010 includes a microphone (MIC) configured to receive an external audio signal when the apparatus 3000 is in the operation mode, such as a call mode, a recording mode, and a speech recognition mode. The received audio signal may be further stored in the memory 3004 or transmitted via the communication component 3016. In some examples, the audio component 3010 further includes a speaker for outputting an audio signal.

The I/O interface 3012 provides an interface between the processing component 3002 and a peripheral interface module which may be a keyboard, a click wheel, a button, etc. These buttons may include but are not limited to: a home button, a volume button, a start button and a lock button.

The sensor component 3014 includes one or more sensors for providing state evaluation of various aspects for the apparatus 3000. For example, the sensor component 3014 may detect an open/closed state of the apparatus 3000, relative positioning of components, such as components being a display and a keypad of the apparatus 3000, and the sensor component 3014 may further detect a change in the position of the apparatus 3000 or of a component of the apparatus 3000, the presence or absence of contact of a user with the apparatus 3000, an orientation or an acceleration/deceleration of the apparatus 3000, and a change in a temperature of the apparatus 3000. The sensor component 3014 may include a proximity sensor configured to detect the presence of nearby objects without any physical contact. The sensor component 3014 may further include an optical sensor, such as a CMOS or CCD image sensor, for use in imaging applications. In some examples, the sensor component 3014 may further include an acceleration sensor, a gyroscope sensor, a magnetic sensor, a pressure sensor, or a temperature sensor.

The communication component 3016 is configured to facilitate wired or wireless communication between the apparatus 3000 and other devices. The apparatus 3000 may access a wireless network based on a communication standard, such as Wi-Fi, 2G or 3G, or their combination. In an example, the communication component 3016 receives a broadcast signal or broadcast-related information from an external broadcast management system via a broadcast channel. In an example, the communication component 3016 further includes a near field communication (NFC) module to facilitate short-range communication. For example, the NFC module may be implemented based on radio frequency identification (RFID) technology, infrared data association (IrDA) technology, ultra wideband (UWB) technology, Bluetooth (BT) technology and other technologies.

In an example, the apparatus 3000 may be implemented by one or more application-specific integrated circuits (ASICs), digital signal processors (DSPs), digital signal processing devices (DSPDs), programmable logic devices (PLDs), field programmable gate arrays (FPGAs), controllers, micro controller units, microprocessors, or other electronic elements for executing any of the methods described herein.

In an example, a non-temporary computer-readable storage medium including instructions, such as the memory 3004 including instructions, which may be executed by the processor 3020 of the apparatus 3000 to complete any of the methods described herein, is further provided. For example, the non-temporary computer-readable storage medium may be a ROM, a random access memory (RAM), a CD-ROM, a magnetic tape, a floppy disk, an optical data storage device, etc.

According to the examples of the disclosure, a discontinuous reception (DRX) mode determining method is provided, the method including: determining an error of a predicted moment when a data packet arrives at a terminal; and determining a DRX mode used by the terminal according to the error, where the DRX mode includes a first mode of determining a DRX configuration according to the predicted moment when the data packet arrives and a second mode corresponding to a preset DRX configuration.

In one example, determining the DRX mode used by the terminal according to the error includes: determining that the terminal uses the first mode in response to the error being within a preset range; or determining that the terminal uses the second mode in response to the error being beyond, or not within, the preset range.

In one example, the error being within a preset range includes at least one of: M errors respectively corresponding to M data packets being greater than or equal to a first error threshold, and M being a natural number smaller than or equal to an overrunning number threshold; or a cumulative sum of each of a plurality of errors respectively corresponding to a plurality of data packets transmitted during an error monitoring cycle being smaller than a second error threshold.

In one example, the M data packets include: M continuous data packets.

In one example, the method further includes: updating M by using a difference of M minus 1 in response to the error corresponding to one of the M data packets being smaller than the first error threshold.

In one example, the error being beyond, or not within, the preset range includes at least one of: N errors respectively corresponding to N data packets being greater than or equal to a first error threshold, and N being greater than an overrunning number threshold, where N is a positive integer; or a cumulative sum of each of a plurality of errors respectively corresponding to a plurality of data packets transmitted during an error monitoring cycle being greater than or equal to a second error threshold.

In one example, the N data packets include: N continuous data packets.

In one example, the method further includes: updating N by using a difference of N minus 1 in response to the error corresponding to one of the N data packets being smaller than the first error threshold.

In one example, determining the DRX mode used by the terminal according to the error includes: determining the DRX mode used by the terminal according to the error after a lasting duration of the terminal using the second mode reaches a first duration.

In one example, determining the error of the predicted moment when the data packet arrives at the terminal includes: determining the error of the predicted moment when the data packet arrives at the terminal during a second duration of the terminal using the second mode.

In one example, the method further includes: using the first mode after a lasting duration of the terminal using the second mode to reach a third duration.

In one example, the first error threshold used by the terminal in the first mode is different from the first error threshold used by the terminal in the second mode; and/or the second error threshold used by the terminal in the first mode is different from the second error threshold used by the terminal in the second mode.

In one example, the DRX configuration includes: a configuration for DRX cycle.

In one example, the configuration for DRX cycle configured by the second mode includes at least one of: a minimum duration in a time interval of each of a plurality of data packets arriving at the terminal during a predetermined configuration period; or a duration of the DRX cycle configured by the second mode is a preset fixed duration.

In one example, the method further includes: determining a duration of off time in the DRX cycle configured by the first mode based on a duration of an interval between an end moment of on time in the DRX cycle, and the predicted moment corresponding to the data packet after the end moment.

In the example of the disclosure, a network side device and/or the terminal determine/determines accuracy of the predicted moment when the data packet arrives at the terminal (i.e., the error between the predicted moment and an actual value moment); and the DRX mode used by the terminal is determined according to the error, where the DRX mode includes the first mode of determining the DRX configuration according to the predicted moment when the data packet arrives and the second mode corresponding to the preset DRX configuration. In this way, based on the error of the predicted moment, the first mode or the second mode is selected and used to determine the DRX configuration, and the DRX configuration that adapts to a change in the error is selected to reduce a problem of increased data transmission delay and power consumption due to inability of the DRX configuration to accurately match with actual arrival of the data packet when the error is too large.

Other implementations of the examples of the disclosure will be apparent to those skilled in the art from consideration of the specification and practice of the disclosure disclosed here. The present disclosure is intended to cover any variations, uses, or adaptations of the examples of the disclosure following the general principles of the examples of the disclosure and including common general knowledge or customary technical means in the technical field not disclosed by the examples of the disclosure. The specification and the examples are merely considered as examples, with a true scope and spirit of the examples of the disclosure being indicated by the following claims.

It is to be appreciated that the examples of the disclosure are not limited to the exact construction that has been described herein and illustrated in the accompanying drawings, and that various modifications and changes may be made without departing from their scope. The scope of the examples of the disclosure is merely limited by the appended claims.

1. A discontinuous reception (DRX) mode determining method,
wherein the method comprises:
determining an error of a predicted moment when a data packet arrives at a terminal; and
determining a DRX mode used by the terminal according to the error, wherein the DRX mode comprises a first mode of determining a DRX configuration according to the predicted moment when the data packet arrives and a second mode corresponding to a preset DRX configuration.

2. The DRX mode determining method according to claim 1, where determining the DRX mode used by the terminal according to the error comprises at least one of:
determining that the terminal uses the first mode on a condition that the error is within a preset range, or
determining that the terminal uses the second mode on a condition that the error is not within the preset range.

3. The DRX mode determining method according to claim 2, wherein the error being within the preset range comprises at least one of:
M errors respectively corresponding to M data packets being greater than or equal to a first error threshold, and M being a natural number smaller than or equal to an overrunning number threshold, or
a cumulative sum of each of a plurality of errors respectively corresponding to the a plurality of data packets transmitted during an error monitoring cycle being smaller than a second error threshold.

4. The DRX mode determining method according to claim 3, wherein the M data packets comprise:
M continuous data packets.

5. The DRX mode determining method according to claim 3, wherein the method further comprises:
updating M by using a difference of M minus 1 on a condition that the error corresponding to one of the M data packets is smaller than the first error threshold.

6. The DRX mode determining method according to claim 2, wherein the error is not within the preset range comprises at least one of:
N errors respectively corresponding to N data packets being greater than or equal to a first error threshold, and N being greater than an overrunning number threshold, wherein N is a positive integer, or
a cumulative sum of each of a plurality of errors respectively corresponding to the a plurality of data packets transmitted during an error monitoring cycle being greater than or equal to a second error threshold.

7. The DRX mode determining method according to claim 6, wherein the N data packets comprise:
N continuous data packets.

8. The DRX mode determining method according to claim 6, wherein the method further comprises:
updating N by using a difference of N minus 1 on a condition that the error corresponding to one of the N data packets is smaller than the first error threshold.

9. The DRX mode determining method according to claim 1, wherein determining the DRX mode used by the terminal according to the error comprises:
determining the DRX mode used by the terminal according to the error after a lasting duration of the terminal using the second mode reaches a first duration.

10. The DRX mode determining method according to claim 1, wherein determining the error of the predicted moment when the data packet arrives at the terminal comprises:
determining the error of the predicted moment when the data packet arrives at the terminal during a second duration of the terminal using the second mode.

11. The DRX mode determining method according to claim 1, wherein the method further comprises:
using the first mode after a lasting duration of the terminal using the second mode to reach a third duration.

12. The DRX mode determining method according to claim 3, wherein at least one of
the first error threshold used by the terminal in the first mode is different from the first error threshold used by the terminal in the second mode, or
the second error threshold used by the terminal in the first mode is different from the second error threshold used by the terminal in the second mode.

13. The DRX mode determining method according to claim 1, wherein the DRX configuration comprises:
a configuration for a DRX cycle.

14. The DRX mode determining method according to claim 13, wherein the configuration for the DRX cycle configured by the second mode comprises at least one of:
a minimum duration in a time interval of each of a plurality of data packets arriving at the terminal during a predetermined configuration period, or
a duration of the DRX cycle configured by the second mode is a preset fixed duration.

15. The DRX mode determining method according to claim 13, wherein the method further comprises:
determining a duration of off time in the DRX cycle configured by the first mode based on a duration of an interval between an end moment of on time in the DRX cycle, and the predicted moment corresponding to the data packet after the end moment.

16-30. (canceled)

31. A communication device apparatus, comprising:
a memory, and
one or more processors, wherein the one or more processors are collectively configured to:
determine an error of a predicted moment when a data packet arrives at a terminal; and
determine a discontinuous reception (DRX) mode used by the terminal according to the error, wherein the DRX mode comprises a first mode of determining a DRX configuration according to the predicted moment when the data packet arrives and a second mode corresponding to a preset DRX configuration.

32. A non-transitory computer-readable storage medium, storing an executable program, wherein the executable program, when executed by one or more processors, cause the one or more processors to collective perform the DRX mode determining method according to claim 1.

33. The communication device apparatus according to claim 31, the one or more processors are further collectively configured to perform at least one of:
determining that the terminal uses the first mode on a condition that the error is within a preset range, or
determining that the terminal uses the second mode on a condition that the error is beyond the preset range.

34. The communication device apparatus according to claim 33, the error being within the preset range comprises at least one of:
M errors respectively corresponding to M data packets being greater than or equal to a first error threshold, and M being a natural number smaller than or equal to an overrunning number threshold, or
a cumulative sum of each of a plurality of errors respectively corresponding to a plurality of data packets transmitted during an error monitoring cycle being smaller than a second error threshold.

35. The communication device apparatus according to claim 33, the error is not within the preset range comprises at least one of:
N errors respectively corresponding to N data packets being greater than or equal to a first error threshold, and N being greater than an overrunning number threshold, wherein N is a positive integer, or
a cumulative sum of each of a plurality of errors respectively corresponding to a plurality of data packets transmitted during an error monitoring cycle being greater than or equal to a second error threshold.
